(19) United States
(12) Patent Application Publication
(10) Pub. No.: US 2015/0356280 A1
(43) Pub. Date: Dec. 10, 2015

(54) SYSTEMS AND METHODS FOR DETERMINING COMPATIBILITY BETWEEN SOFTWARE LICENSES

(71) Applicant: HEWLETT-PACKARD DEVELOPMENT COMPANY, L.P., Houston, TX (US)

(72) Inventor: Giancarlo Lori, Rome (IT)

(73) Assignee: HEWLETT-PACKARD DEVELOPMENT COMPANY, L.P., Houston, TX (US)

(21) Appl. No.: 14/759,894

(22) PCT Filed: Jan. 30, 2013
(86) PCT No.: PCT/US2013/023770

§ 371 Date: Jul. 8, 2015

(51) Int. Cl. G06F 21/10

(52) U.S. Cl. CPC G06F 21/105; G06F 2221/0759

(57) ABSTRACT

A non-transitory storage device stores instructions that, when executed by a processor, causes the processor to receive, from an input device, input identifying software licenses for software components to be included in an application. The instructions also cause the processor to receive usage information identifying how the application is to be used, determine whether an incompatibility exists between a first one of the software licenses for a first software component and a second one of the software licenses for a second software component, and based on a determination of the existence of an incompatibility, display a recommendation by the processor as to how to avoid the incompatibility.

### BACKGROUND

When writing source code, a developer may use already-written segments of code rather than creating such functionality on their own. In many cases, the segments of code that are to be incorporated into the developer's application are subject to an open source software (OSS) license. Many different types of OSS licenses exist and the terms of the licenses vary from license to license. The increasing use of software that is subject to OSS licenses poses a logistical problem of keeping track of the restrictions and obligations imposed by the various OSS licenses.

OSS licenses have numerous terms. By way of example, one OSS license term may require that, if the software that is covered by that license is modified by the developer, the entire application (not just the code segment subject to the OSS license, but the entire application) must be published. Some terms may require publication of the source code in certain situations while other terms may require that the executable code be released for all to use subject to the certain license terms. Another OSS license term may require that, in certain situations, credit be given to the author of the code segment subject to the license. The variety of licenses is growing and the applicable terms are voluminous. Keeping track of the applicable obligations and restrictions is problematic.

### BRIEF DESCRIPTION OF THE DRAWINGS

For a detailed description of examples of the disclosure, reference will now be made to the accompanying drawings in which:

FIG. 1 shows a system in accordance with various examples;

FIG. 2 depicts inputs to the usage definition of an application in accordance with various examples;

FIG. 3 shows a method in accordance with various examples; and

FIG. 4 shows another method in accordance with various examples.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various examples of the disclosure. Although one or more of these examples may be preferred, the examples disclosed should not be interpreted, or otherwise used, as limiting the scope of the disclosure, including the claims. In addition, one skilled in the art will understand that the following description has broad application, and the discussion of any example is meant only to be exemplary of that example, and not intended to intimate that the scope of the disclosure, including the claims, is limited to that example.

In accordance with various examples of the present disclosure, compatibility is determined between open source software (OSS) licenses of two or more software components utilized in a broader project. In order to combine two or more components into a broader project, the components must be suitable for their intended usage in the project. If the OSS licenses permit the intended usage, they are compatible; if there is no way to satisfy both licenses at once, they are incompatible. The determination of compatibility becomes more complex as the number of components subject to OSS licenses in a project increases.

A project definition specifies the OSS components to be used in the project and, for each component, an intended usage or action for the component (e.g., will be used without modification, will be modified, or will be linked to another component). In the case where a component is to be linked to a second component, the second component is specified as well. The project definition also specifies the intended usage of the project and an IP position describes whether the source code will be disclosed and the type of delivery specifies whether the project will be used internally, distributed to a client or re-licensed.

Each component license is then analyzed for compatibility with other component licenses. One example of incompatibility would be where one component is governed by a GNU General Public License (GPL) and another component is governed by a Mozilla Public License (MPL). Each license allows modification of the associated component, but with the requirement that the project be licensed under the terms of the component license upon redistribution. If the action for both components specifies modification and the project is to be distributed, there is an incompatibility because it is not possible to relicense the project under two different licenses at the same time.

In the event of an incompatibility, a recommendation is displayed to the user as to how to avoid the incompatibility. In the above scenario, for example, the recommendation may be to search for a substitute for one of the two conflicting components (e.g., by designing a similar component in-house or by locating a substitute component that does not require relicensing the product using a conflicting license). Another example of a recommendation may be, “You should restructure the relationship with the client so that the client provides the software instead of you. Instead, you should provide a service (rather than a product) to the client to modify their software.” Thus, the need to license any of the OSS components that created the incompatibility is avoided.

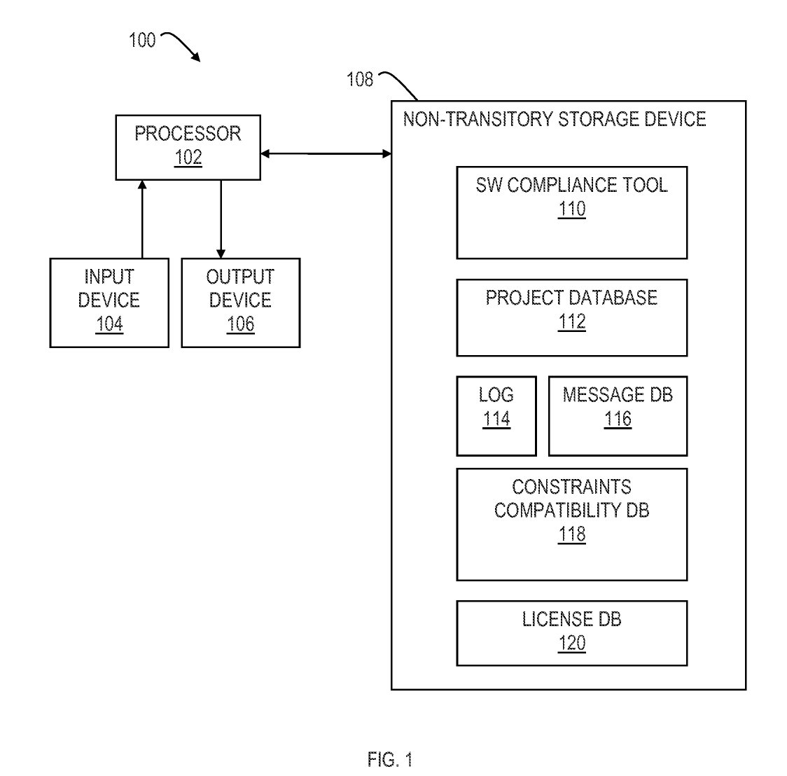

FIG. 1 illustrates a system 100 that includes a hardware processor 102 (e.g., central processing unit, “CPU”) coupled to an input device 104, an output device 106, and a non-transitory storage device 108. Although a single hardware processor 102 is shown in the example of FIG. 1, more than one hardware processor can be included in other examples. The input device 104 may include a keyboard, a mouse, a trackball, or combinations thereof. The output device 106 may include a display. A user interacts with the system of FIG. 1 via the input and output devices 104 and 106.

The non-transitory storage device 108 may include random access memory (“RAM”), a hard disk drive, a compact disc read-only memory (“CD ROM”), Flash storage, and other non-transitory storage devices. The storage device 108 stores a software compliance tool 110 that includes machine-readable instructions that may be executed by the processor 102. Execution of the software compliance tool 110 by processor 102 causes the processor 102 to implement some or all of the functionality described herein. The storage device 108 may also include log data 114, a message database 116, a constraints compatibility database 118, and a license database 120.

The software compliance tool 110 permits a user to create a description of a software project. The project includes a software application that has been or is being created by an author (e.g., a software developer). For ease of discussion, the project may be discussed in the future tense, but the software tool 110 can be used to analyze a software project that already exists as well.

The project to be created will include source code, some of which will be written by the author and some of which will include software components that the author will not create but will incorporated into the project nevertheless. For example, the author may download a particular software component, or multiple software components into the project. The use of such software components authored by a person other than the author of the project avoids the author from having to create a software component that already exists thereby streamlining the development of the software project. The term “software component” in this disclosure refers to a collection of machine-readable instructions that are to be used in a software project, but that may not be written by the author of the project.

One or more of the software components may be subject to a software license, sometimes referred to as an “open source software license.” Such licenses permit the corresponding software component to be used but pursuant to certain restriction and constraints. Numerous different types of open source software exist or may be created in the future.

A restriction comprises a limitation on what can be done with the software component. Examples of restrictions that may be placed on a software component by way of its open source software license include:
A. Source code of the software component may not be modified
B. Source code may not be used for commercial use
C. Modifications to the source code are permitted and such modifications may be distributed in a form separate from the original source, such as a patch.
   Different or other restrictions are possible as well.

A constraint includes an obligation that the author of the project must perform. A constraint is an affirmative action that the author must take, whereas a restriction is a forbidden action. Examples of constraints include:
A. Return back the modification of the software component.
B. Distribute the source code of the software component.
C. Give credit to the original author of the software component.
D. Re-license the resulting project with the same software license.
   Different and/or additional constraints are possible as well. One type of constraint is called a “reciprocal constraint.” A reciprocal constraint is a constraint obligation that applies in certain conditions that requires that the developer, who is using a software component, to contribute his work to the original author. For example, the constraint “return back to the author any modification to the original source code” is a reciprocal constraint, or “distribute/re-license the entire work under the same original license” is another reciprocal constraint.

A software license defines restrictions and constraints that may apply to one or more “objects.” An object may comprise source code, binary code, a derivative software work, etc. In some implementations, the license database 120 includes one or more open source software licenses and the terms (e.g., restrictions and constraints) of such licenses. Each license may be stored in the database 120 in the form of an object class instantiation. As such, each license may include multiple objects interrelated to one or more other objects. In at least some implementations, a license is represented in the database 120 with four designations—“license,” “object,” “action,” and “constraint.” These designations permit the software compliance tool 110 to represent most, if not all, clauses in the various licenses. The designation “license” contains attributes such as name of the license, version, description, dates of validity, etc. The designation “object” defines objects in the license and on which the rules or terms of the license are applied. Examples of object include “source code,” “binary code,” “derivative works,” and “license.” Other types of objects can be defined. The designation “action” contains any action that is subject to the rules of the license itself. Examples of actions include “modify source code,” “distribute,” “link,” “copy,” “use,” etc. If a particular action is allowed for a given object, a relationship will be specified in the database between the object and the action. The designation “constraint” represents the obligations required under the license. For a given license, the user of the software compliance tool 110 can specify which objects the license governs. This operation is performed via a user interface implemented by the software compliance tool 110. The user interface displays the various “license,” “object,” “action,” and “constraint” information using, for example, a tree representation. The root of the tree is the license. The objects are displayed at the second level of the tree representation. The third level provides the permitted actions, and the fourth level of the tree provides the constraints associated to the action.

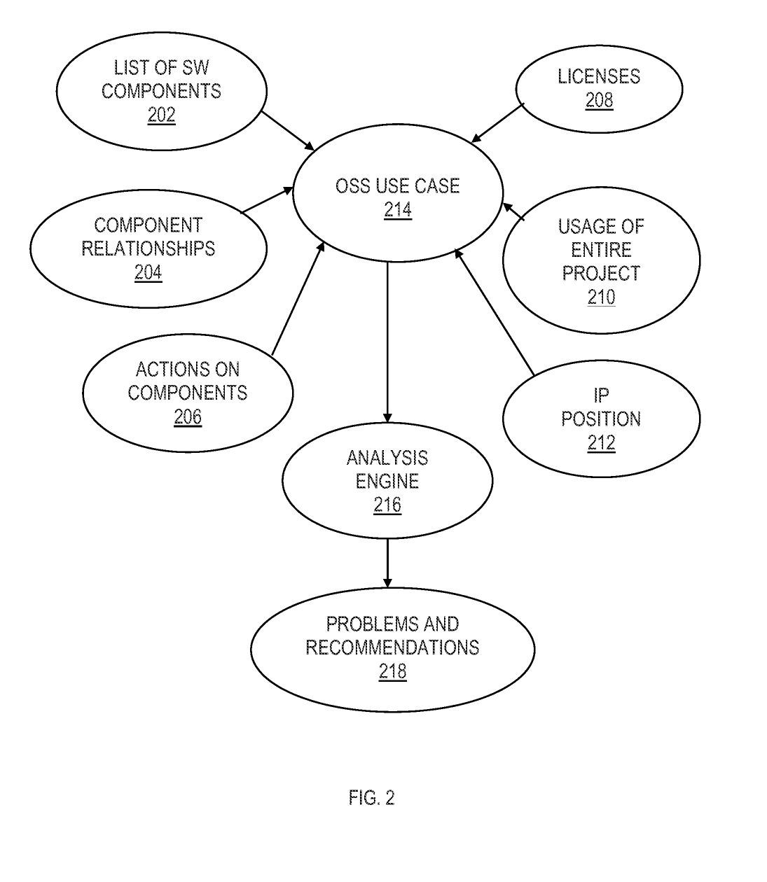

FIG. 2 illustrates the operation of the software compliance tool 110 to create and analyze an OSS use case 214 for the project. The use case 214 for a given project defines how the project is intended to be used and which software components and associated open source software licenses will be used in the project. The OSS use case 214 is constructed from a number of inputs including one or more software components 202, component relationships 204, actions on the software components 206, OSS licenses 208, usage of the entire project 210, and an “intellectual property” (IP) position 212 for the project. The various inputs are provided by a suitable user interface implemented by the software compliance tool 110.

The list of software components 202 is input by, for example, selection from a menu of software component choices, by typing in the name of the software components, or by any other suitable manner. The component relationships 204 specify, for example, the manner in which each software component is related to the overall project. Examples of such relationships 204 include static linking and dynamic linking.

The actions on the software components 206 specify the manner in which the corresponding software component is to be implemented or has been implemented. Examples of software component actions include “modify,” “link,” and “use only.” The modify action means that the author of the project intends to modify the software component's source code. The link action means that the author of the project intends to link the software component with, for example, a library. The use only action means that the author intends to incorporate the software component without modification into the project.

The licenses 208 identify the OSS licenses that control the use of the specified software components 202. The OSS licenses 208 may include known licenses (e.g., GNU General Public License (GPL), Apache License 2.0, or Mozilla Public License (MPL)) as well as future created licenses. Known licenses may be selected from a menu. Licenses can also be specified by typing the names of the licenses. Through a user interface, the user of the software compliance tool 110 is able to associate each software component 202 with a corresponding license 208. More than one software component 202 may be covered by (i.e., correspond to) the same license 208.

A user interface may be provided by which the various terms of the license may be specified by the user of the software compliance tool 110. Software licenses can include any of numerous possible terms. An illustrative example includes: if the source code is modified, the source code must be published; any project using the applicable software component must be relicensed under the same license terms as the license pertaining to the software component. Such licenses and license term information is stored in the storage device 108 in license database 120.

The project usage 210 input specifies how the project that includes the various software components 202 and associated licenses 208 is intended to be used and delivered. Project usage 210 may specify the business usage of the project. An example of a project's usage includes: the project is for internal use only (project will be used just by the author or the author's organization and will not be distributed or sold). Another project usage example includes: the project will be delivered to a customer. Such latter project usage may also specify whether the customer-delivered project may be resold by the customer or used only by the customer itself. A project usage input may also be that the project is to be used in a particular industry (e.g., military). Project usage information is stored in the project database 112.

The IP position 212 specifies some of the terms of the overall license to be imposed on the resulting project. Examples of IP positions include:
A. Re-licensing: specifies that the project is to be released under a proprietary software license.
B. Open artifact: specifies that the project is to be released under an open source software license.
C. Close artifact: specifies that the project is to be released with a proprietary license that controls any source code written by the author and, for software components that are incorporated into the project, such software components are controlled by their own OSS licenses.

Referring still to FIG. 2, once the OSS use case 214 is constructed by a user of the software compliance tool 110, an analysis engine 216 (which may be part of the tool 110 or a separate software application) then analyzes the use case to determine if any problems exist and, if so, provides one or more recommendations 218.

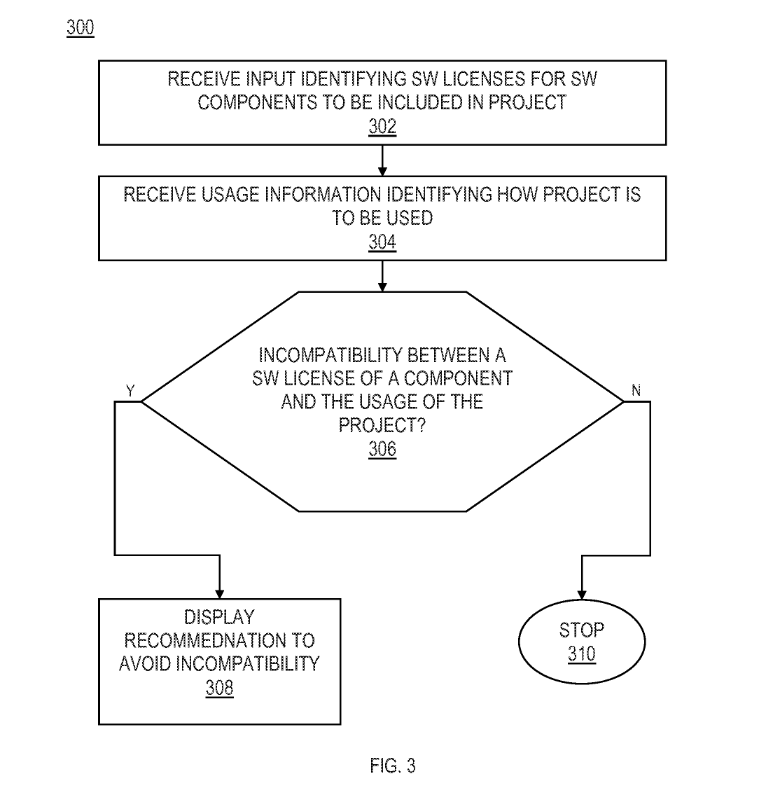

FIG. 3 shows a method 300 for how the software compliance tool determines problems and provides recommendations (218). The actions provided in FIG. 3 can be performed in an order different than that shown and two or more actions may be performed in parallel. The method 300 may be performed by software compliance tool 110.

The method 300 begins with receiving input identifying software licenses for software components to be included in the project (block 302). The method also includes receiving project usage information that identifies how the application is to be used (block 304). Example illustrations of blocks 302 and 304 are provided above.

The method 300 continues with determining whether an incompatibility exists between a software license for a first software component and another software license for a second software component (block 306). This determination may be implemented in accordance with a variety of techniques. In one embodiment, a user such as a programmer specifies an action for each component (e.g., modify the component, use the component without modification, link the component to another component). The user also specifies a usage for the entire project including its IP position and a project delivery type.

The software compliance tool 110 begins analysis with a license of a first component utilized in the project. If an action for the first component is not allowed by its license (e.g., action is to modify component and the project is to be distributed but the license prohibits distribution of any modified version of the component), an incompatibility is identified and a message to the user is generated. For example, one message could be, “Find an equivalent software component to component A (i.e., the first component) having a license that does not require public disclosure of project source code.” Another message could be, “Renegotiate with customer to have customer develop project internally with externally-provided support service.” In this case, the resulting project will not be delivered from one party to another and the resulting project will be used internally only by customer who created it.

If the action specified for the first component is allowed by its license, the software compliance tool 110 identifies any constraints required by the license to maintain compatibility with the license. For example, a particular action might invoke a particular constraint (e.g., if the component is modified and the project is distributed, then the project must be relicensed under the same license terms). The software compliance tool 110 performs similar analysis for other licenses in the project; that is, constraints are identified based on the intended action for all components utilized in the project. After constraints for each component have been identified based on the actions for the various components, the tool determines whether an incompatibility exists among the various constraints.

For example, a user of the software compliance tool 110 may have previously created a constraints compatibility database 118 (FIG. 1) and stored such database in the storage device 108. One example of such constraints compatibility database 118 includes a table that identifies incompatible constraints for a particular constraint. That is, for each constraint, a number of incompatible other constraints are identified. For example, a constraint from an OSS license for one or more of the software licenses of the constituent software components may require that the resulting project be licensed using the same license terms if the component is modified. However, a second component having different license terms contains the same requirement. The programmer has determined that it is necessary to modify both components. In this case, the constraints compatibility database 118 would identify, for each constraint, that other constraints requiring relicensing under different license terms are incompatible, and thus an incompatibility is identified. By providing such license, obligation, and constraint information in one or more databases 112, 116, 118, analyzing the compatibility of OSS licenses of multiple software components of a project is greatly simplified.

As noted above, the system 100 also may include a message database 116 stored in the storage device 108. The message database 116 includes one or more messages corresponding to one or more incompatibilities. Each message specifies a recommendation as to how the corresponding incompatibility can be resolved. The message database 116 includes alphanumeric character strings that can be displayed on output device 106 to provide feedback to the user of the software compliance tool 110 as to how to resolve one or more incompatibilities between intended actions for components and OSS licenses for other software components that are to be included in the project.

Referring again to FIG. 3, the method 300 further includes displaying the recommendation message to avoid the incompatibility determined at block 306 (block 308). Otherwise, if no incompatibility is determined at block 306, the method terminates at block 310.

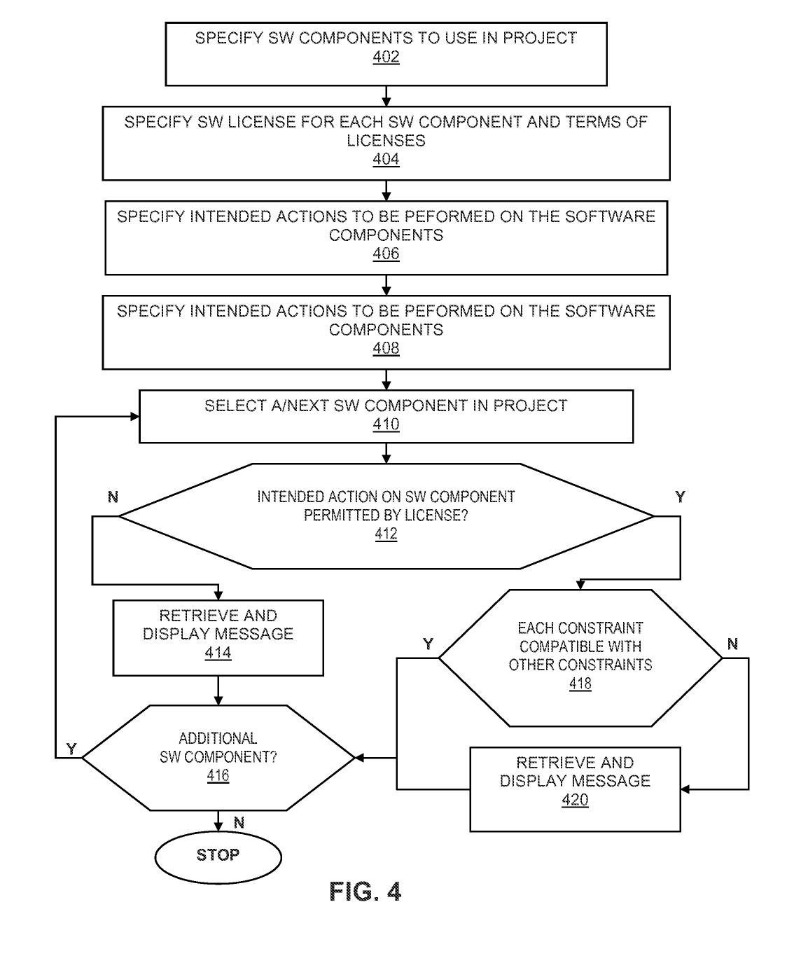

FIG. 4 shows another method 400 performed by the software compliance tool 110 upon is execution by hardware processor 102. The actions provided in FIG. 4 can be performed in an order different than that shown and two or more actions may be performed in parallel. The method 400 provides, among other things, additional detail regarding the component constraint analysis introduced above. The method 400 may be performed by software compliance tool 110.

The method 400 begins with specifying software components to use in the project (block 402). The method 400 continues with specifying a software license for each of the various software components specified at 402, as well as the terms of the licenses including any applicable constraints (block 404). In some embodiments, a given software component may have been used in a previous project and thus its applicable software license will have been designated in the former project. For such previously used software component, block 404 may include the software compliance tool 110 searching a repository of software component designations (e.g., project database 112) and their applicable software tools. The method 400 includes specifying the intended actions to be performed on the various software components (e.g., modify, link, or use only) (block 406). If, for example, the action specified on the software component is “modify” (i.e., modification of the software component), the software compliance tool 110 may automatically add a new software component to the project that represents the derivative work of the original software component, and on this newly added software component, the user can specify the intended use. At block 408, the business usage for the project is specified. Such actions are discussed above as well.

The remaining actions depicted in the method 400 include the analysis of the various software components in relation to constraints imposed by licenses of other software components for the project. At block 410, a software component specified at block 402 is selected to be analyzed. At block 412, the method 400 determines whether the intended action for that software component (specified at 406) is permitted by the software license pertaining to that particular software component. If the action is not permitted, then at block 414 the method 400 comprises retrieving and displaying a message from the message database 116. The message may identify that a problem exists and provide a recommendation as to how to remedy the problem. For example, the message may be that the intended modification to the software component is not permitted by the applicable software license and that the problem can be remedied by changing the action specified for that software component to “use only” (i.e., no modification). If an additional software component remaining to be analyzed exists in block 416, then the method 400 returns to block 410; otherwise, the method 400 terminates.

If the intended action is permitted by the applicable software license, then the method continues in block 418. At block 418, the method 400 includes, for each constraint specified by the applicable software license for the software component, determining whether each such constraint is compatible with the applicable constraints of other components' licenses. Constraints compatibility database 118 may be used for this purpose as explained above.

If the constraints of the various licenses are compatible as determined at block 418, then the method 400 continues to block 416 to determine if an additional software component in the project remains to be analyzed. If the constraints of the various licenses are not compatible at block 418, then the method 400 retrieves an applicable message from message database 116, which provides a recommendation as to how to remedy the incompatibility (block 420) and control then passes to 416.

In at least some implementations, all incompatibilities and recommendation messages determined for the given project are stored in log 114 for subsequent viewing.

The above discussion is meant to be illustrative of the principles and various examples of the present disclosure. Numerous variations and modifications will become apparent to those skilled in the art once the above disclosure is fully appreciated. It is intended that the following dams be interpreted to embrace all such variations and modifications.

What is claimed is:

1. A non-transitory storage device storing instructions that, when executed by a processor, causes the processor to:
receive, from an input device, input identifying software licenses for software components to be included in an application;
receive, from the input device, usage information identifying how the application is to be used;
determine whether an incompatibility exists between a first one of the software licenses for a first software component and a second one of the software licenses for a second software component; and
based on a determination of the existence of an incompatibility, display a recommendation by the processor as to how to avoid the incompatibility.

2. The non-transitory storage device of claim 1 wherein the usage information comprises at least one of:
an indication that the application is for internal use only; and
an indication that the application will be delivered to a third party for use by the third party.

3. The non-transitory storage device of claim 1 wherein the instructions that, when executed by the processor, cause the processor to determine whether an incompatibility exists comprise instructions that, when executed by the processor, cause the processor to determine whether an incompatibility exists between any of the software licenses for the software components and an overall license assigned to the application.

4. The non-transitory storage device of claim 3 wherein the instructions, when executed by the processor, cause the processor to determine whether an incompatibility exists by comparing terms in the software licenses for the software components to terms in the overall license agreement.

5. The non-transitory storage device of claim 1 wherein the instructions that, when executed by the processor, determine whether an incompatibility exists comprise instructions that, when executed by the processor, cause the processor to determine whether a publication term of a software license is inconsistent with usage information of the application.

6. The non-transitory storage device of claim 1 wherein the instructions that, when executed by the processor, display a recommendation comprise instructions that, when executed by the processor, display a message indicating that consideration should be given to renegotiating with a customer to permit publication of application.

7. The non-transitory storage device of claim 1 further comprising instructions that, when executed by the processor, cause the processor to associate each of a plurality recommendation messages with a corresponding incompatibility.

8. The non-transitory storage device of claim 1 further comprising instructions that, when executed by the processor, cause the processor to store constraints compatibility information in a database, said constraints compatibility information indicative of, for each constraint type, which other constraint types are incompatible.

9. A method, comprising:
receiving, from an input device, input identifying software licenses for software components to be included in an application;
receiving, from the input device, usage information identifying how the application is to be used;
determining, by a processor, whether an incompatibility exists between a first one of the software licenses for a first software component and a second one of the software licenses for a second software component; and
based on a determination of the existence of an incompatibility, displaying a recommendation by the processor as to how to avoid the incompatibility.

10. The method of claim 9 wherein the usage information comprises at east one of:
an indication that the application is for internal use only; and
an indication that the application will be delivered to a third party for use by the third party.

11. The method of claim 9 wherein determining whether an incompatibility exists further comprises determining whether an incompatibility exists between any of the software licenses for the software components and an overall license assigned to the application.

12. The method of claim 11 further comprising determining whether an incompatibility exists by comparing terms in the software licenses for the software components to terms in the overall license agreement.

13. The method of claim 9 further comprising storing constraints compatibility information in a database, said constraints compatibility information indicative of, for each constraint type, which other constraint types are incompatible.

14. A non-transitory storage device storing instructions that, when executed by a processor, causes the processor to:
receive, from an input device, input identifying software licenses for software components to be included in an application;
receive, from the input device, actions intended to be performed on the software components;
receive, from the input device, usage information identifying an intended business usage of the project;
determine whether an incompatibility exists between a specified action for each software component and a software license corresponding to said software component;
determine whether an incompatibility exists between a constraint of a software license for a first software component and constraints of software licenses of one or more other components; and
based on a determination of the existence of an incompatibility, display a recommendation as to how to avoid the incompatibility.

15. The non-transitory storage device of claim 14 wherein the instructions that, when executed by the processor, cause the processor to determine whether an incompatibility exists between a constraint of a software license for a first software component and constraints of software licenses of one or more other components, comprise instructions that, when executed by the processor, cause the processor to determine whether an incompatibility exists between a constraint of the software license for the first software component and one or more constraints of an overall license assigned to the application.
